(19) United States
(12) Patent Application Publication
(10) Pub. No.: US 2001/0055038 A1
(43) Pub. Date: Dec. 27, 2001

(54) Method for changing menu icon and editing menu configuration in a mobile telephone

(75) Inventor: Hyung-Chul Kim, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/847,002

(22) Filed: May 1, 2001

(30) Foreign Application Priority Data
Jun. 8, 2000 (KR) 31340/2000

(51) Int. Cl. G06F 3/14

(52) U.S. Cl. 345/810; 345/825

(57) ABSTRACT

Disclosed is a method for editing a main menu configuration in a mobile telephone. The method comprises displaying a menu edit screen, if a menu edit submenu is selected; displaying a menu configuration submenu, if a menu configuration edit submenu is selected; editing the menu configuration submenu by newly selecting submenus of the menu configuration submenu; and storing the edited menu configuration in the name of a title input by the user.

### PRIORITY

This application claims priority to an application entitled “Method for Changing Menu Icon and Editing Menu Configuration in a Mobile Telephone” filed in the Korean Industrial Property Office on Jun. 8, 2000 and assigned Serial No. 2000-31340, the contents of which are hereby incorporated by reference.

### BACKGROUND OF THE INVENTION

1. Field of the Invention

The present invention relates generally to a mobile telephone, and in particular, to a method for changing a menu icon and editing a menu configuration in a mobile telephone.

2. Description of the Related Art

At present, most mobile subscribers prefer a mobile telephone with unique functionality and an appearance different from other telephones. For example, mobile telephones include the functions of mobile messaging, voice dialing, caller ID, phone directory, a clock calendar, etc. In addition, the user can choose mobile telephones that have different appearances such as mobile telephones that come in an assortment of colors, designs, weight, etc. However, the existing mobile telephone does not include a function for creating a user-defined menu icon, so the user cannot create his or her own user-defined menu icon.

In addition, the existing mobile telephones have a fixed menu configuration, which does not allow a user to edit the menu configuration. Further, the user of a mobile telephone may be regrettably charged a call fee because mobile telephones may be fraudulently used by others when the mobile telephone does not include a lock function.

A need therefore exists for mobile telephones that include a function for creating a user-defined menu icon where a user is capable of creating the menu icon. In addition, a need exists for mobile telephones that include an apparatus and method for editing a menu configuration or a submenu configuration. Further, a need exists to provide an apparatus and method for providing a lock function, to mobile telephones, to prevent fraudulent use of the mobile telephones.

### SUMMARY OF THE INVENTION

It is, therefore, an object of the present invention to provide a method for changing a menu icon by downloading a desired menu icon through a communication network such as an IP (Internet Protocol) network.

It is another object of the present invention to provide a user-defined menu configuration in a mobile telephone in order to allow a user to edit a menu configuration.

In accordance with one aspect of the present invention, there is provided a method for changing a menu icon in a mobile telephone. The method comprises downloading menu icon data from a web server connected to an IP (Internet Protocol) network; converting the menu icon data to be suitable for a display of the mobile telephone and storing the converted menu icon data as menu icons; sending an icon set change request from a user; displaying a set of the stored menu icons upon receipt of said icon set change request from said user; and displaying desired ones of a set of the menu icons by selection of the user on a main menu screen.

In accordance with another aspect of the present invention, there is provided a method for editing a main/sub menu configuration in a mobile telephone. The method comprises displaying a menu edit screen, if a menu edit submenu is selected; displaying a menu configuration submenu, if a menu configuration edit submenu is selected; editing the menu configuration by newly selecting submenus of the menu configuration submenu; and storing the edited menu configuration in the name of a title input by the user. Submenu configurations may be edited in a similar manner.

Further, the method comprises displaying the menu configuration titles edited by the user, if a menu configuration select submenu is selected on the menu edit screen; and changing the main menu configuration displayed on a display of the mobile telephone to the menu configuration stored in the name of the title selected by the user.

Further, the method comprises requesting the user to input a lock code required to enter the menu edit submenu; determining whether the input lock code is identical to a prescribed lock code; and displaying the menu edit submenu, if the input lock code is identical to the prescribed lock code.

### BRIEF DESCRIPTION OF THE DRAWINGS

The above and other objects, features and advantages of the present invention will become more apparent from the following detailed description when taken in conjunction with the accompanying drawings in which:

FIG. 1 is a system diagram for explaining how a mobile telephone downloads a menu icon according to an embodiment of the present invention;

FIG. 2 is a block diagram illustrating a mobile telephone according to an embodiment of the present invention;

FIG. 3 is a diagram illustrating an SMS (Short Message Service) data format for transmitting menu icon data together with SMS user data according to an embodiment of the present invention;

FIGS. 4A and 4B are flow charts illustrating a procedure for changing a menu icon and editing a menu configuration according to an embodiment of the present invention;

FIGS. 5A to 5F are diagrams illustrating the menu screens displayed during the editing of the menu configuration according to an embodiment of the present invention; and

FIGS. 6A to 6C are diagrams illustrating the menu screens displayed during selection of a menu configuration according to an embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

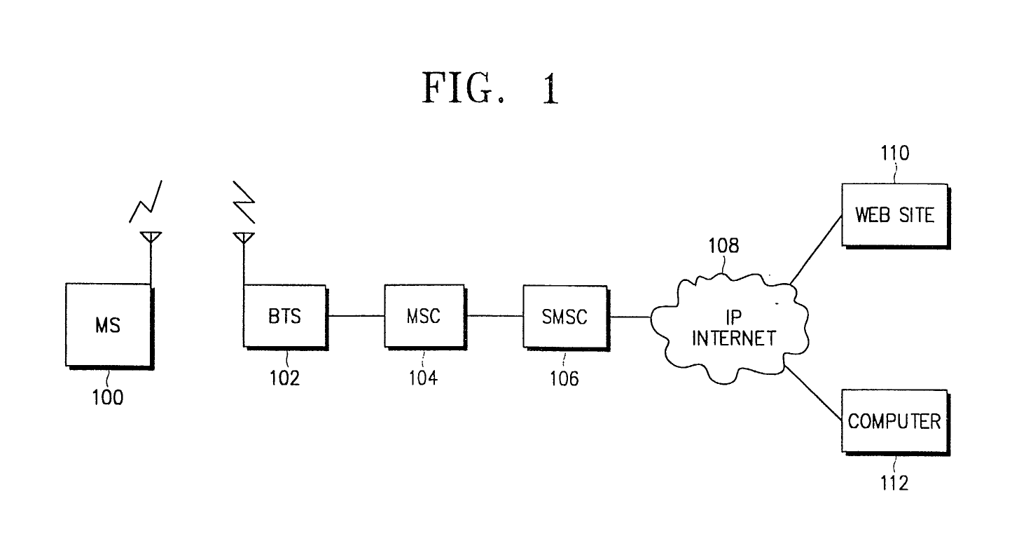

FIG. 1 is a system diagram for explaining how a mobile telephone downloads a menu icon according to an embodiment of the present invention.

Referring to FIG. 1, a personal computer 112, at the user's request, accesses a menu icon, through an IP (Internet Protocol) network 108, from a web site 110, and downloads a menu icon selected by the user. Upon receipt of a menu icon request from the mobile telephone (or mobile station (MS)) 100, the personal computer 112 transmits the downloaded menu icon data to an SMSC (SMS Center) 106 to which the mobile telephone 100 belongs. In addition, after editing the desired menu icon it is also possible to download the menu icon. Alternatively, the user can, in the personal computer 112, select any one of the desired menu icons stored in the personal computer 112, edit the selected menu icon suitable for the main menu configuration of the mobile telephone 100, and then transmits the edited menu icon to the mobile telephone 100 through a cable or a wireless LAN (Local Area Network) connected between the personal computer 112 and the mobile telephone 100.

The SMSC 106 is utilized to process an SMS message that is exchanged between the mobile telephone 100 and a base station transceiver subsystem (BTS) 102. In an embodiment of the present invention, the SMSC 106 receives the menu icon data (series of menu icon data) requested by the user through IP network 108, then inserts the menu icon data in SMS user data, and transmits the SMS user data to the mobile telephone 100 through the BTS 102.

Upon receipt of the SMS message including the menu icon data from the SMSC 106, the mobile telephone 100 converts the menu icon data to be suitable for an LCD (Liquid Crystal Display) format and stores the converted menu icon data in its internal memory. If the user desires to exchange the current initial menu icon for the received menu icon, then the mobile station 100 selects the desired menu icon from the menu icons stored in the memory and displays the selected menu icon as a new initial menu icon.

A mobile switching center (MSC) 104 transmits the SMS message, including the menu icon data, from the SMSC 106 to the mobile telephone 100 through the BTS 102. The mobile telephone 100 extracts the menu icon data from the received SMS message and stores the extracted menu icon data. Next, the user of the mobile telephone 100 selects a menu icon that needs to be changed, than replaces the selected menu icon with the menu icon received through the SMS message.

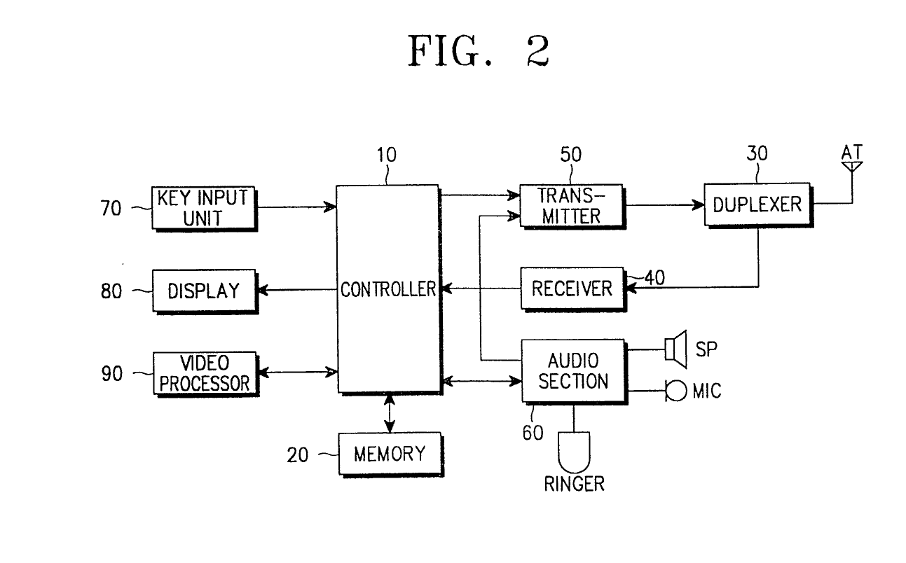

FIG. 2 shows a block diagram of the mobile telephone 100 according to an embodiment of the present invention. The mobile telephone 100 includes an Internet protocol for providing a mobile Internet service and a graphic LCD for displaying menu icons.

Referring to FIG. 2, a controller 10 controls the overall operation of the mobile telephone 100. According to an embodiment of the present invention, in particular, the controller 10 controls an access to the IP network 108 and data communication between the mobile telephone 100 and the IP network 108. A memory 20 stores a control program of the mobile telephone 100 and data generated during execution of the control program. Further, the memory 20 stores in its predetermined area the menu icon transmitted from the web site 110 or the menu icon included in the SMS data transmitted from the SMSC 106 according to an embodiment of the present invention. When the menu icon is transmitted through the SMS data, the menu icon data generally exceeds a capacity of the SMS data. Therefore, the menu icon must be segmented into several SMS data before transmission.

A duplexer 30 communicates with the BTS 102 through an antenna AT and separates transmission signals from reception signals. A receiver 40, under the control of the controller 10, receives a radio signal through the antenna AT and the duplexer 30, and then the receiver 40 amplifies the received low-power radio signal, and filters the amplified radio signal. A transmitter 50, under the control of the controller 10, filters a radio signal output from an audio section 60, then the transmitter 50 amplifies the filtered radio signal, and transmits the amplified radio signal through the duplexer 30 and the antenna AT. The audio section 60, under the control of the controller 10, modulates an audio signal received from a microphone MIC into a radio signal. In addition, the audio section 60 demodulates the radio signal received through the receiver 40 and outputs the demodulated signal through a speaker SP as an audio signal. In addition, when the receiver 40 detects a ring signal transmitted from the BTS 102, the audio section 60 generates a ring tone through a ringer. A key input unit 70, comprised of a plurality of alphanumeric keys, generates key data according to a key pressed by the user and provides the generated key data to the controller 10.

A display 80, under the control of the controller 10, displays various status information of the mobile telephone 100. In particular, the display 80 displays the key data received from the key input unit 70 and various information received from the controller 10. In addition, the display 80 is comprised of a graphic LCD so as to display the menu icons according to an embodiment of the present invention. A video processor 90, under the control of the controller 10, processes various menu icon data received from a communication network such as an IP network and various menu icon data received through an input/output port of the mobile telephone 100, so as to display the menu icon data on the display 80.

FIG. 3 shows an SMS data format for transmitting menu icon data together with SMS user data according to an embodiment of the present invention.

Referring to FIG. 3, the menu icon has a various data size and is generally too large in size to be transmitted using the SMS data. Therefore, the menu icon must be segmented into a plurality of SMS data before transmission. Accordingly, the first several bytes of the SMS user data are used for information about the menu icon data. A typical example of the SMS data format will be described with reference to FIG. 3.

The SMS data format includes a SMS data field 300, a menu icon information field 302, and a user data field 304. The SMS data field 300 is a special field provided by the maker according to an embodiment of the present invention, utilized to determine that data included in the SMS data is not an SMS message but special data. The menu icon information field 302 is filled with information indicating that data included in the user data field 304 is menu icon data. The user data field 304 includes a present data sequence information field 306, a total icon data byte number field 308 and an icon data information field 310. The present data sequence information field 306 is a field where the actual icon data is filled, and indicates the sequence of the presently transmitted icon data. The total icon data byte number field 308 indicates into how many SMS data the icon data should be segmented. The icon data information field 310 is filled with the actual icon data information. Upon receipt of such SMS user data, the mobile telephone 100 can reassemble the segmented menu icon data into the original menu icon by analyzing the received SMS user data. In addition, the mobile telephone 100 determines whether the received SMS data is the icon data, and if so, converts the SMS data to icon data and stores the converted SMS data.

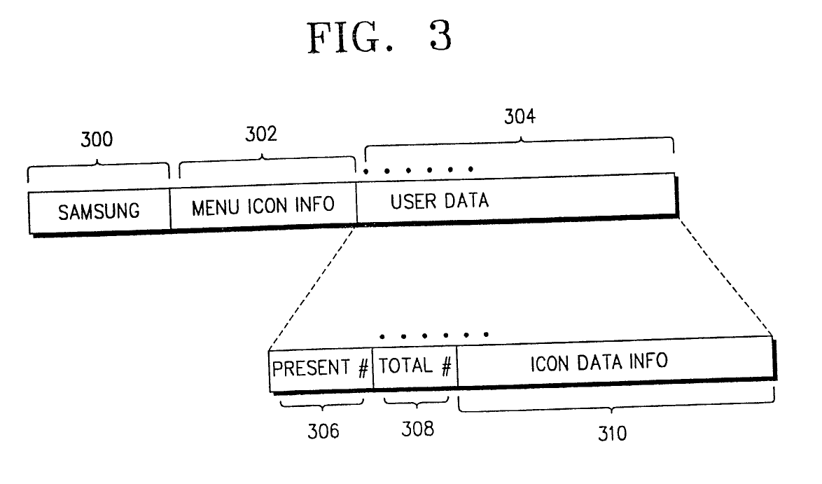

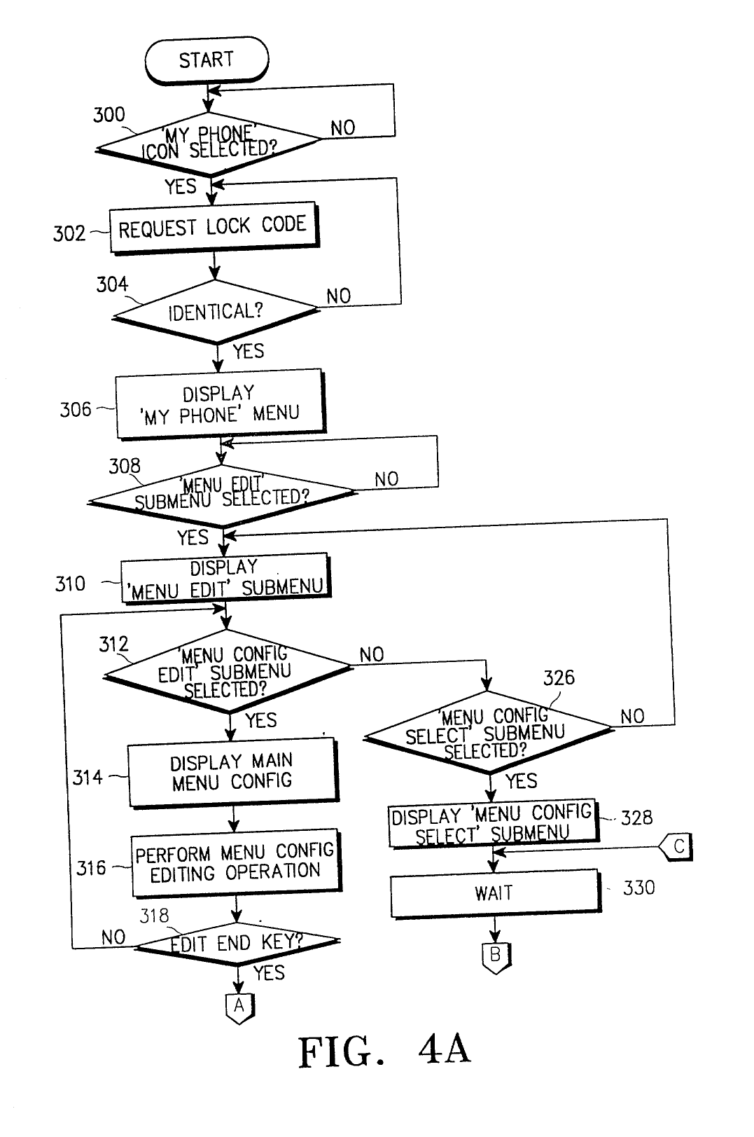

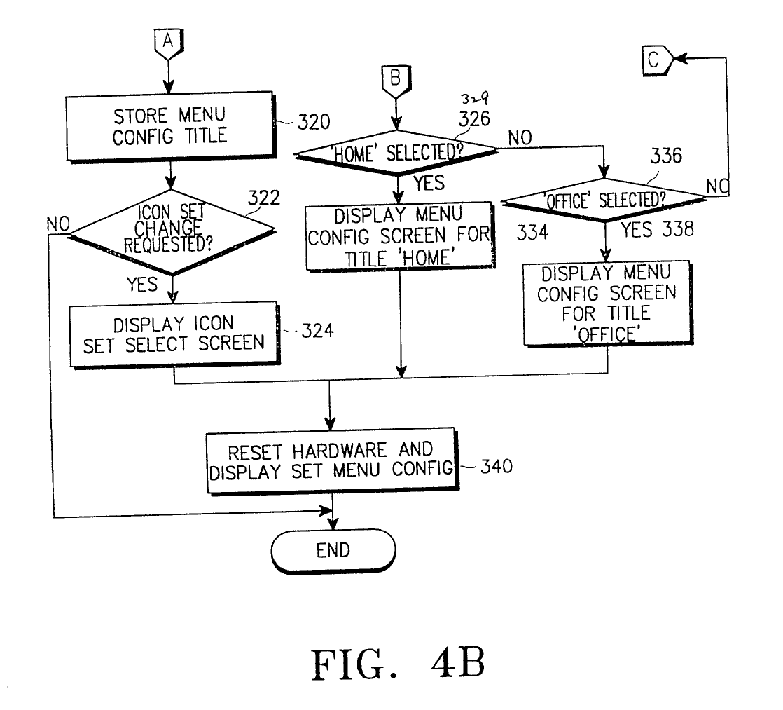

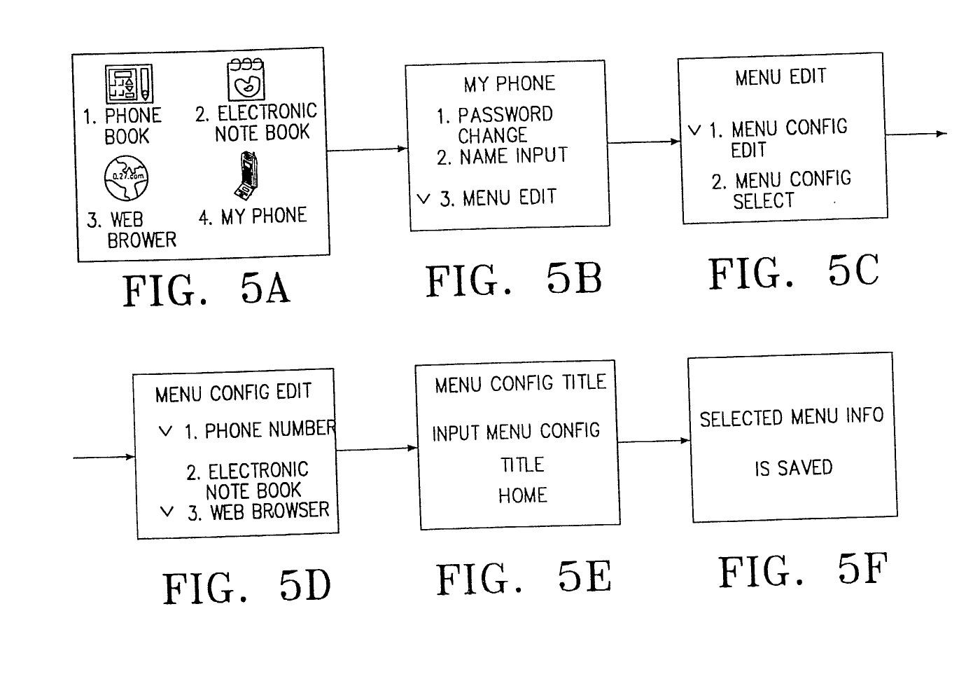

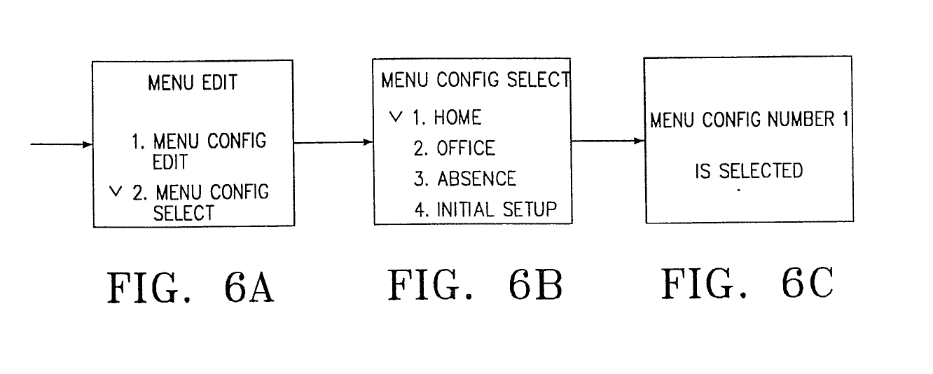

FIGS. 4A and 4B are flow charts illustrating a procedure for changing a menu icon and editing a menu configuration according to an embodiment of the present invention; FIGS. 5A to 5F are diagrams illustrating the menu screens displayed during editing of the menu configuration according to an embodiment of the present invention; and FIGS. 6A to 6C are diagrams illustrating the menu screens displayed during selection of a menu configuration according to an embodiment of the present invention.

Now, a detailed description will be made of a preferred embodiment of the present invention with reference to FIGS. 2 to 6C.

The mobile telephone 100 has an initial main menu configuration, shown in FIG. 5A by way of example, comprised of a Phone Book icon, an Electronic Note Book icon, a Web Browser icon and a My Phone icon. Those of ordinary skill in the art will recognize that any device such as a personal digital assistant (PDA), mobile handset, a mobile handset supporting a PDA function, or an electronic organizer that includes a menu configuration may utilize this invention. According to an embodiment of the present invention, although the main menu screen includes 4 main menus, the main menu configuration may be varied according to the maker of the mobile telephone. The My Phone icon is used to select a menu for updating personal information of the user. By selecting this menu, the user can change various personal information set in the mobile telephone 100 and edit the main menu screen configuration according to an embodiment of the present invention.

When it is intended to edit the main/sub menu configuration, the user will select the My Phone icon on the main menu screen using key input unit 70. The controller 10 determines in step 300 of FIG. 4A whether the user inputs (or presses) a first key for selecting the My Phone icon. Upon receipt of the first key input for selecting the My Phone icon by the user, the controller 10 requests the user to input a lock code (or password) required to enter the My Phone menu in step 302. The lock code is required to prevent another person from changing the personal information registered in the My Phone menu. In answer to the lock code input request, the user will input the lock code to enter the My Phone menu. The controller 10 then recognizes the lock code input through key input unit 70 by the user and determines in step 304 whether the lock code input by the user is identical to a prescribed lock code. If the input lock code is not identical to the prescribed lock code, the controller 10 returns to step 302 and requests again an input of the lock code.

Otherwise, if the input lock code is identical to the prescribed lock code, the controller 10 displays the My Phone menu shown in FIG. 5B in step 306. The My Phone menu includes a Password Change submenu for changing the lock code required to enter the My Phone menu, and a Name Input submenu for inputting the telephone user's name which is normally displayed on the initial screen. In addition, the My Phone menu includes a Menu Edit submenu for enabling the user to edit the main menu screen on the display 80 according to an embodiment of the present invention. If it is intended to edit the main menu screen of the mobile telephone, the user will select the Menu Edit submenu of the My Phone menu.

In step 308, the controller 10 determines whether the user inputs a second key for selecting the Menu Edit submenu. In step 310, upon receipt of the second key input for selecting the Menu Edit submenu by the user, the controller 10 displays, on the display 80, the Menu Edit submenu shown in FIG. 5C. The Menu Edit submenu includes a Menu Configuration Edit submenu and a Menu Configuration Select submenu. In step 312, the controller 10 determines whether the user selects the Menu Configuration Edit submenu. If the user selects the Menu Configuration Edit submenu, the controller 10, on the display 80, displays the main menu configuration, shown in FIG. 5D, in step 314 so as to enable the user to select (or designate) only the desired main menus out of the main menus. For example, when it is intended to display only the Phone Book icon and the Web Browser icon on the main menu screen, the user can edit (or change) the main menu configuration by designating the Phone Book menu and the Web Browser menu as shown in FIG. 5D using the key input unit 70. In step 316, according to the designation of the menus by the user, the controller 10 performs a menu configuration editing operation. Next, in step 318, the controller 10 determines whether the user inputs an edit end key. If the user inputs the edit end key, the controller 10 requests, in step 320, the user to input a title of the edited menu configuration and stores, in the memory 20, the newly edited menu configuration in the name of the title input by the user.

For example, when the menu configuration includes the menus to be used at home, the user may input “Home” as the title of the menu configuration as shown in FIG. 5E. Alternatively, the user may input “Home”, “Office” or “Absence” as shown in FIG. 6B according to the feature of the menu configuration. The controller 10 then displays a message of, for example, “Selected Menu Information is Saved” on the display 80 as shown in FIG. 5F to inform the user of successful execution of the menu configuration editing operation, and stores in the memory 20 the edited menu configuration in the name of the menu configuration title.

In step 322, subsequently, the controller 10 determines whether the user requests a change of an icon set. Upon receipt of an icon set change request from the user, the controller 10 displays an icon set select screen stored in the memory 20 and stores an icon set selected by the user, in step 324. According to an embodiment of the present invention, the icon set is downloaded as SMS data from the IP network 108 that was previously stored in the memory 20 according to an embodiment of the present invention. By doing so, the user can create the menu screen using a desired menu set. In step 340, the controller 10 resets the hardware of the mobile telephone 100 and displays the set menu configuration on the display 80, completing the menu configuration editing process.

Otherwise, if the user does not select the Menu Configuration Edit submenu in step 312, the controller 10 determines in step 326 whether the user selects a Menu Configuration Select submenu as shown in FIG. 6A. If the user selects the Menu Configuration Select submenu, the controller 10 displays in step 328 a Menu Configuration Select submenu screen shown in FIG. 6B, comprised of “Home”, “Office”, “Absence” and “Initial Setup”. If the user does not select a Menu Configuration Select submenu at step 326, the process returns to step 310.

In step 330, the controller 10 waits until the user selects one of the menu configuration titles. If the user selects a menu configuration title “Home” as shown in FIG. 6B in step 329, the controller 10, on the display 80, displays a message “Menu Configuration Number 1 is Selected” as shown in FIG. 6C. Then, in step 334, the controller 10 displays a menu configuration screen corresponding to the selected menu configuration title “Home”. Subsequently, in step 340, the controller 10 resets the hardware of the mobile telephone 100 and displays the set menu configuration on the display 80.

Otherwise, if the user selects the menu configuration title “Office” in step 336, the controller 10 displays a message “Menu Configuration Number 2 is Selected” on the display 80. Then, in step 338, the controller 10 displays a menu configuration screen corresponding to the selected menu configuration title “Office”. Subsequently, in step 340, the controller 10 resets the hardware of the mobile telephone 100 and displays the set menu configuration on the display 80. If the user does not select the “office” title, the process returns to step 330.

Although the present invention has been described with reference to the case where the menu configuration titles include “Home”, “Office” and “Absence”, it is also possible to change the menu configuration titles and add new menu configuration titles.

While the invention has been shown and described with reference to a certain preferred embodiment thereof, it will be understood by those skilled in the art that various changes in form and detail may be made therein without departing from the spirit and scope of the invention as defined by the appended claims.

What is claimed is:

1. A method for changing a menu icon in a mobile telephone, the method comprising:
downloading menu icon data from a web server connected to an IP (Internet Protocol) network;
converting the menu icon data to icon form suitable for a display of the mobile telephone and storing the converted menu icon data as menu icons;
upon receipt of an icon set change request from a user, displaying a set of the stored icons; and
displaying desired ones of a set of the menu icons by selection of the user on a main menu screen.

2. The method as claimed in claim 1, wherein in the downloading step, the menu icon data downloaded from the web server is transmitted to an SMS (Short Message Service) center and the SMS center transmits the menu icon data together with SMS data to the mobile telephone through a base station transceiver subsystem (BTS).

3. The method as claimed in claim 2, wherein the menu icon data is segmented into a plurality of SMS data before transmission and is reassembled into original menu icon data at the mobile telephone.

4. A method for changing a menu icon in a mobile telephone, further comprising:
editing a main menu screen configuration by selecting desired ones of icons stored in a database;
downloading the selected menu icon data through a cable or wireless LAN (Local Area Network) connected between the database and the mobile telephone; and
changing the downloaded menu icon data to prescribed menu icons displayed on a main menu screen.

5. The method as claimed in claim 4, wherein the editing further comprises:
accessing an icon providing web site connected to an IP network using a personal computer;
selecting desired menu icons out of menu icons downloaded from the web site and storing the selected menu icons in the database of the personal computer; and
editing the main menu screen configuration using the menu icons stored in the personal computer database.

6. A method for editing a main menu configuration in a mobile telephone, the method comprising:
displaying a menu edit screen, if a menu edit submenu is selected;
displaying a menu configuration submenu, if a menu configuration edit submenu is selected;
editing the menu configuration by newly selecting submenus of the menu configuration submenu;
inputting titles of the selected submenus; and
storing the edited menu configuration in the name of a title input by the user.

7. The method as claimed in claim 6, further comprising:
displaying the menu configuration titles edited by the user, if a menu configuration select submenu is selected on the menu edit screen; and
changing the main menu configuration displayed on a display of the mobile telephone to the menu configuration stored in the name of the title selected by the user.

8. The method as claimed in claim 6, further comprising:
requesting the user to input a lock code required to enter the menu edit submenu;
determining whether the input lock code is identical to a prescribed lock code; and
displaying the menu edit submenu, if the input lock code is identical to the prescribed lock code.
